(19) United States
(12) Patent Application Publication
(10) Pub. No.: US 2014/0094290 A1
(43) Pub. Date: Apr. 3, 2014

(54) PLAYER SELECTABLE GAMING GROUP

(71) Applicant: Michael Jabara, Las Vegas, NV (US)

(72) Inventor: Michael Jabara, Las Vegas, NV (US)

(21) Appl. No.: 14/015,717

(22) Filed: Aug. 30, 2013

Related U.S. Application Data
(60) Provisional application No. 61/707,074, filed on Sep. 28, 2012.

(51) Int. Cl. G07F 17/32

(52) U.S. Cl. CPC G07F 17/3258; G07F 17/3272
USPC 463/26

(57) ABSTRACT

In a gaming system which includes one or more gaming machines, players are able to form specifically designated groups. A player may form a group of other designated players or may designate other gaming machines to be included in a group. Based upon player input of players or machines, a group is formed. In one embodiment, a jackpot is associated with the group. In event a designated winning criteria is met by a player in the group then the jackpot is award to one or more players of the group.

### RELATED APPLICATION DATA

This application claims priority to U.S. Provisional Application Ser. No. 61/707,074, filed Sep. 28, 2012.

### FIELD OF THE INVENTION

The present invention relates to gaming machines and awards for wagering game wins.

### BACKGROUND OF THE INVENTION

Casinos continue to seek new and exciting games to present to players in order to maintain player interest. In this vein, gaming machine manufacturers have produced gaming machines having various themes, entertaining displays and the like.

One problem with gaming machines is that the play thereof is generally a solitary activity. Thus, some players would rather play table games as such games involve significant player interaction.

In order to stimulate player interest in gaming machine play, large jackpots may be offered. For example, the MEGABUCKS® game offered by IGT is presented at linked slot machines. This game offers a very large jackpot for a player who achieves a particular combination of symbols at one of the slot machines. One problem with this game is that the jackpot is very infrequently awarded. In addition, a player may engage in a high volume of play of the game only to have some unknown player in another location win the jackpot.

As a result, additional new and exciting features for wagering games and gaming machines are desired.

### SUMMARY OF THE INVENTION

Embodiments of the invention comprise methods and systems of playing and presenting games. In one embodiment, the present invention comprises a player-configurable group.

In a gaming system which includes one or more gaming machines, players are able to form specifically designated groups. A player may form a group of other designated players or may designate other gaming machines to be included in a group. Based upon player input of players or machines, a group is formed. In one embodiment, a jackpot is associated with the group. In the event a designated winning criteria is met by a player in the group then the jackpot is awarded to one or more players of the group.

Further objects, features, and advantages of the present invention over the prior art will become apparent from the detailed description of the drawings which follows, when considered with the attached figures.

### DESCRIPTION OF THE DRAWINGS

FIG. 1 illustrates a gaming system in accordance with one embodiment of the invention at which features of the invention may be implemented.

### DETAILED DESCRIPTION OF THE INVENTION

In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

Embodiments of the invention comprise methods of playing and presenting games. In general, the present invention comprises a player-configurable gaming group. One or more players may form a group of other designated players or may designate gaming machines to be included in a group. Based upon player input of players or machines, a group is formed. In one embodiment, a jackpot is associated with the group. In the event a designated winning criteria is met by a player in the group then the jackpot is awarded to one or more players of the group.

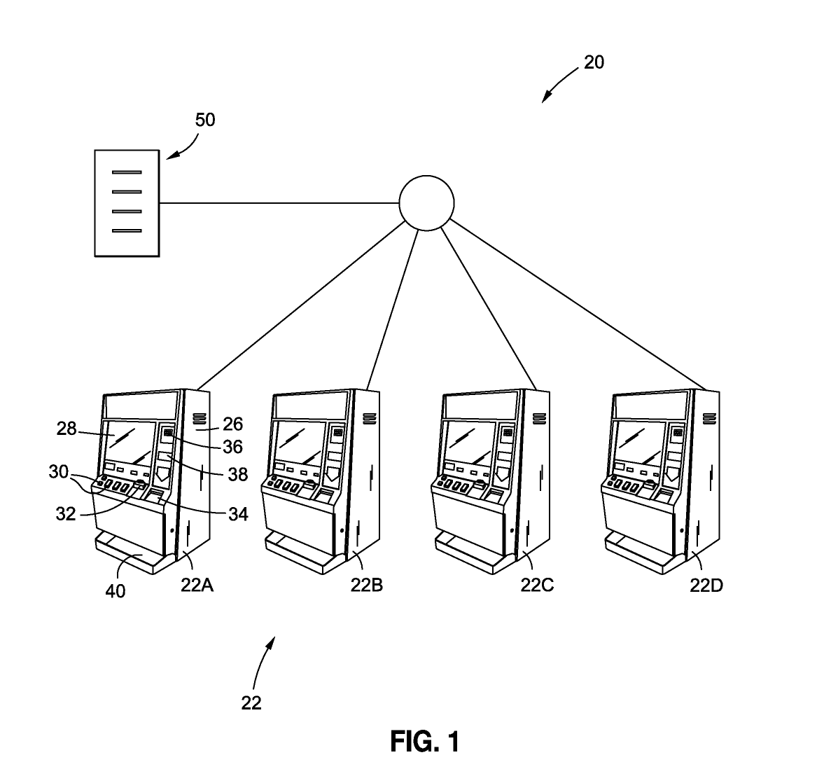

In a preferred embodiment, the methods of game play and presentation are implemented via one or more gaming machines or devices. FIG. 1 illustrates one configuration of a gaming machine 22 via which the invention may be implemented.

The gaming machine 22 may be located at a casino (and as such is referred to as a “casino gaming machine”). As described below, the gaming machine 22 may be part of a gaming system, such as a casino gaming system which links multiple of the gaming machines, one or more table games and other devices such as kiosks, accounting systems or servers, progressive systems or servers, player tracking systems or servers or the like.

As illustrated, the gaming machine 22 generally comprises a housing or cabinet 26 for supporting and/or enclosing various components required for operation of the gaming machine. In the embodiment illustrated, the housing 26 includes a door located at a front thereof, the door capable of being moved between an open position which allows access to the interior, and a closed position in which access to the interior is generally prevented. The configuration of the gaming machine 22 may vary. In the embodiment illustrated, the gaming machine 22 has an “upright” configuration. However, the gaming machine 22 could have other configurations, shapes or dimensions (such as being of a “slant”-type, “bar-top” or other configuration as is well known to those of skill in the art).

The gaming machine 22 preferably includes at least one display device 28 configured to display game information. The display device 28 may comprise an electronic video display such as a cathode ray tube (CRT), high resolution flat panel liquid crystal display (LCD), projection LCD, plasma display, field emission display, digital micro-mirror display (DMD), digital light processing display (DLP), LCD touchscreen, a light emitting display (LED) or other suitable displays now known or later developed, in a variety of resolutions, sizes and formats (e.g. 4:3, widescreen or the like). The display 28 may be capable of projecting or displaying a wide variety of information, including images, symbols and other indicia or information associated with game play, game promotion or other events.

In another embodiment, the gaming machine 22 may include one or more physical reels capable of displaying symbols. In such a configuration, means are provided for rotating the physical reels. In one or more embodiments, the means may comprise a mechanical linkage associated with a spin arm, with movement of the spin arm (a Apull@) by a user causing the reels to spin. In such an arrangement, the reels are generally allowed to free-wheel and then stop. In another embodiment, electronically controlled mechanisms are arranged to rotate and stop each reel. Such mechanisms are well known to those of skill in the art. In this arrangement, actuation of the spin arm or depression a spin button causes a controller (not shown) to signal the activation of the spin mechanism associated with one or more of the reels. Preferably, the controller is arranged to either turn off the signal to the device(s) effecting the rotation of each or all of the reels or generates a signal for activating a braking device, whereby the reels are stopped. As is well known, the combinations of reel positions and their odds of hitting are associated with the controller, and the controller is arranged to stop the reels in a position displaying a combination of indicia as determined by the controller based on the combinations and odds. The principal of such an arrangement is described in U.S. Pat. No. 4,448,419 to Telnaes, which is incorporated herein by reference. For example, the base symbols might be associated with spinning reels. Sets of base symbols might be generated by spinning those reels.

As described in more detail below, the gaming machine 22 is preferably configured to present one or more games upon a player making a monetary payment or wager. In this regard, as described in more detail below, the gaming machine 22 includes means for accepting monetary value.

In one embodiment, as detailed above, certain game outcomes may be designated as winning outcomes. Prizes or awards may be provided for winning outcomes, such as monetary payments (or representations thereof, such as prize of credits), or promotional awards as detailed herein. As detailed below, the gaming machine 22 includes means for returning unused monetary funds and/or dispensing winnings to a player.

The gaming machine 22 preferably includes one or more player input devices 30 (such as input buttons, plunger mechanisms, a touch-screen display, joystick, touch-pad or the like). These one or more devices 30 may be utilized by the player to facilitate game play, such as by providing input or instruction to the gaming machine 22. For example, such input devices 30 may be utilized by a player to place a wager, cause the gaming machine 22 to initiate a game, to indicate cards to be held or discarded, to “cash out” of the gaming machine, or to provide various other inputs.

In one preferred embodiment, the gaming machine 22 includes at least one microprocessor or controller for controlling the gaming machine, including receiving player input and sending output signals for controlling the various components of the machine 22 (such as generating game information for display by the display 28). The controller may be arranged to receive information regarding funds provided by a player to the gaming machine, receive input such as a purchase/bet signal when a purchase/bet button is depressed, and receive other inputs from a player. The controller may be arranged to generate information regarding a game, such as generating game information for display by the at least one display 28 (such as information representing images of displayed cards), for determining winning or losing game outcomes and for displaying information regarding awards for winning game outcomes, among other things.

The controller may be configured to execute machine readable code or “software” or otherwise process information, such as obtained from a remote server. Software or other instructions may be stored on a memory or data storage device. The memory may also store other information, such as pay table information. The gaming machine 22 may also include one or more random number generators for generating random numbers, such as for use in selecting cards and for presenting the game in a random fashion.

Preferably, the controller is configured to execute machine readable code or instructions which are configured to implement the method of game play of the invention. For example, the controller of the gaming machine 22 may be configured to detect a wager, such as a signal from a player's depressing of the “bet one” button. Upon such an event and/or the player otherwise signaling the gaming machine to present the game, the controller may be configured to cause game information to be displayed on the at least one display 28. The controller may accept input from a player of via the one or more player input devices of the gaming machine 22.

The gaming machine 22 may be configured to generate and present games in a stand-alone manner or it may be in communication with one or more external devices at one or more times. For example, the gaming machine 22 may be configured as a server based device and obtain game code or game outcome information from a remote game server (in which event the gaming machine controller may receive game information from the server, such as game outcome information, and use that server-generated information to present the game at the gaming machine).

As indicated, the gaming machine 22 is configured to present one or more wagering games. Thus, the gaming machine 22 is preferably configured to accept value, such as in the form of coins, tokens, paper currency or other elements or devices representing value such as monetary funds. For example, as illustrated in FIG. 1, the gaming machine 22 might include a coin acceptor 32 for accepting coins. Of course, associated coin reading/verifying devices and coin storage devices may be associated with the gaming machine 22 if it is configured to accept coins. Likewise, the gaming machine 22 might include a media reader 34. Such a reader may be configured to accept and read/verify paper currency and/or other media such as tickets. Of course, in such event the gaming machine 22 may further be configured with one or more paper currency or ticket storage devices, such as cash boxes, and other paper currency or media handling devices (including transport devices).

The gaming machine 22 might also be configured to read FOBs, magnetic stripe cards or other media having data associated therewith and via which value or funds may be associated with the gaming machine 22.

In one embodiment, the gaming machine 22 is configured to award winnings for one or more winning wagering game outcomes. Such winnings may be represented as credits, points or the like. In one embodiment, the player may “cash out” and thus remove previously associated funds and any awarded winnings or such may otherwise be paid to the player. For example, upon an award or at cash-out, associated funds may be paid to the player by the gaming machine 22 dispensing coins to a coin tray 40. In another embodiment, funds may be issued by dispensing paper currency. In yet another embodiment, a player may be issued a media, such as a printed ticket, which ticket represents the value which was paid or cashed out of the machine. The aspects of gaming machine “ticketing” systems are well known. One such system is described in U.S. Pat. No. 6,048,269 to Burns, which is incorporated herein in its entirety by reference.

The gaming machine 22 may also include a player tracking device, such as a card reader 38 and associated keypad 36. Such player tracking devices are well known and may permit the game operator to track play of players of the gaming machine. The tracked play may be utilized to offer player bonuses or awards.

It will be appreciated that the gaming machine illustrated in FIG. 1 is only exemplary of one embodiment of a gaming machine. For example, it is possible to for the gaming machine to have various other configurations, including different shapes and styles and having different components than as just described.

For example, it is possible for the game of the invention to be presented on a computing device, including at a home or office computer. In one embodiment, a player might log in to a casino server and the controller of the casino server may cause game information to be delivered to the player's computer and then be displayed on a display of the player's computer. In this regard, it will be noted that the term “controller” may comprise more than one device. For example, in a server-based environment, a controller at a server may generate game information and transmit that information to a local controller at a gaming machine. The local controller at the gaming machine may then cause game information to be displayed on the display of the gaming machine. The games of the invention could also be presented by or at hand-held devices, such as PDAs, cellular phones, tablet computing devices or the like.

A casino may have numerous such gaming machines 22, such as located on a casino floor or in other locations. Of course, such gaming machines 22 might be used in other environments, such as an airport, a bar or tavern or other locations.

One embodiment of the invention comprises a player selectable group. In accordance with the present invention, one or more players may define a group of two or more players. One or more awards, such as a progressive jackpot, may be defined which are specifically awardable to one or more players of the group.

One example of the invention will be described with reference to FIG. 1. As illustrated therein, a casino gaming system 20 includes a first gaming machine 22A, a second gaming machine 22B, a third gaming machine 22C and a fourth gaming machine 22D. Preferably, all of the gaming machines 22A-D are in communication with one another and/or a game server 50. Although the gaming machines 22A-D are shown as being similar, the gaming machines 22A-D may be heterogeneous and diverse and may include local and remote gaming machines, gaming machines made by different manufacturers, and/or gaming machines configured to play different games. In groups where multiple types of games are played (e.g., blackjack and video poker), outcomes for each game may be normalized such that winning outcomes in different games are given similar values.

In one embodiment of the invention, players of the one or more gaming machines 22A-D may form a player group. This player group defines particular players or gaming machines, preferably as specifically selected by player input. Players and gaming machines which are not selected are not included in the group.

For example, a gaming machine 22 may be configured to display a graphical user interface which permits a player to designate a player group. The interface might be displayed, for example, based upon a player's selection of a “form player group” button displayed on a display of the gaming machine 22.

In response to the interface, the player may be presented with the opportunity designate one or more players to form a player group. For example, the player might be presented with a map which shows the location of various gaming machines. The player might be permitted to select particular gaming machines from the map, such as by touching their location on the displayed map. In such a configuration, those specific gaming machines and the players thereof are linked into a group.

In another embodiment, the gaming system 20 may be configured to track players, such as through the use of a player tracking system. Such systems are well known in the art. In one configuration of such a system, information regarding each player is stored at the server 50. The stored information may include, for example, the player's name, contact information, tracked game play data, and an identifier which is used to identify the player. The identifier might comprise a unique code which is also associated with a media, such as a magnetic stripe player card. In use of such a system, a player may identify themselves at a gaming machine, such as by inserting their player card. The system uses the identifier to determine the identity of the player and can then track activities of the player at the gaming machine.

In one embodiment, the “form player group” interface might comprise one or more fields into which the player might enter the names (or other identifiers such as nicknames, user names or the like) of other players. This information could be sent to the server 50 which matches the player names to those in the stored player tracking information. If a player name matches one in the database and that player is currently playing one of the gaming machines, then the server 50 can identify the player and their associated gaming machine for use in forming a player group, as detailed below.

In another embodiment, the interface might include a map which shows gaming machines and the names or nicknames of players who are actively playing those machines (to the extent the players of the machines have identified themselves using the player tracking system). The map may include only players who have opted-in to joining groups or may exclude players who have opted-out from joining groups. In such event, the player might scan the names for the names of friends and then select particular players using the displayed names. Unidentified players might be shown as “unknown” and the player might also be permitted to select unknown players. Players may indicate (e.g., via a gaming machine, the player tracking system, or otherwise) that they are interested in joining a group and the map may indicate which players have expressed such an interest.

Using the information provided by the player, the gaming system 20 preferably forms a player group of two or more players. For example, based upon selected gaming machines, the server 50 may form a group which comprises the player's gaming machines and each other gaming machine identified by the player. In the case of selected names, the server 50 may use the names to identify the associated gaming machines which those players are playing, thus again forming a player group.

In a preferred embodiment of the invention, a jackpot is associated with the player group. In a most preferred embodiment of the invention, the jackpot is a progressive jackpot. The progressive jackpot may or may not have an initial seed value (such as a minimum value). Preferably, the size of the jackpot grows over time, such as based upon game play by the players of the designated player group (such as by a portion of wagers placed by players of the group).

In one embodiment, if one or more winning criteria are met by game play of one or more of the players of the designated player group, then the jackpot is awarded. For example, the jackpot might be awarded to the first player of the group who achieves a Royal Flush while playing a video poker game. In one embodiment, the entire jackpot may be awarded to the single player who achieves the winning criteria. In another embodiment, the jackpot may be split among the players of the group. In this configuration, the jackpot might be split in equal shares, or the player who achieved the winning criteria might be awarded a higher amount than the other players.

Of course, the invention may have various configurations.

In one embodiment the player group may only remain in effect for a particular period of time. For example, the player group might remain in effect for 1 hour, 1 day or 1 week, regardless of whether the jackpot winning criteria was met. The player group may also be disbanded after a winning criteria.

A player might only be permitted to be part of one player group at a time, or might be permitted to be part of more than one player group.

In one embodiment, players might be sent an invitation to join a group when another player selects them. The invited player might accept or decline. A player might also be required to place a side bet or pay value to join a player group or to form a player group.

In one embodiment, players might be required to play certain gaming machines in order to be part of a group, or only game play at certain gaming machines may be tracked. For example, a player of a video poker gaming machine might form a group via which a progressive jackpot is awarded for achieving a Royal Flush. In that event, only game play at other video poker gaming machines may be relevant to the group. This is a particular advantage of forming a player group by identified player: each time the named player is identified to be playing a gaming machine on the system, the player's play can be evaluated for participation in the group. For example, a player of an identified group might be playing a video poker game when the group is first formed, which play is relevant to the group. Later the player may quit playing that machine and play a slot machine. While that player is still part of the group, the player's play of the slot machine may not be relevant to the group and thus may not contribute to the progressive jackpot or entitle that player to win the jackpot. However, if that player then later goes and plays a video poker machine, that tracked game play may again be associated with the group.

In this regard, the players of a group may be playing gaming machines at the same time or they may be playing at different times. In addition, the players may be playing gaming machines which are located adjacent to one another or they might be in different parts of a casino or even in other casinos or other remote locations (including via mobile devices from remote locations, work, home, etc.). Accordingly, a group may be formed of players who are currently playing and/or players who are not currently playing. The outcomes of games played by players in the group may be accumulated during the lifespan of the group. For example, a progressive jackpot may increase based on the intermittent, continuous, contemporaneous and/or non-contemporaneous of the players in the group.

In one embodiment a primary or first player forms a group by designating one or more second players. It is possible for second players to be entitled to designate additional players to join a group. In such event the primary player might have the right to accept or deny entry of such third players into the group.

Players might also merge groups. For example, two groups of 10 players might be permitted to merge into a single group of 20 players.

Of course, the gaming system 20 may be configured to display various information about the player groups, such as various graphical user interfaces at the gaming machines. Such interfaces may include various tools and the like by which players may form groups, merge groups, send invitations, decline invitations, check jackpot values and the like. Of course, a variety of machine readable and executable instructions/code or “software” may be utilized by one or more servers, gaming machines or other system devices in order to implement the features of the invention.

The invention has numerous advantages. In the prior art, one or more gaming machines have been linked such that game play at those specific machines may be associated with a jackpot. In such a configuration, however, a player has no control over the players or gaming machines in the group. For example, in the prior art, a bank of 5 gaming machines may be linked together and be associated with a common jackpot. However, a player of one of those machines has no control over the identity of players of the other machines. In addition, a player of that bank of gaming machines cannot play with/against players of gaming machines other than those in that designated bank of machines.

In accordance with the invention, players have control over the formation of a player group. Thus, by specific player input, a player group can be formed of specific players or of certain gaming machines.

One advantage of the invention is that a player might form a small group, such as just two players. For example, a husband and wife or two close friends can form their own closed group. This lends excitement because the two players know that they alone are members of the group and are the only ones who qualify to win the designated group jackpot.

In other situations, a player might form a very large group in order that a higher volume of play might result in higher jackpot values.

In some embodiments, game tournaments may be played between groups, with each group acting as a unit for purposes of the tournament. The cumulative or average outcomes within a group may be used to determine a winner between groups.

It will be understood that the above described arrangements of apparatus and the method there from are merely illustrative of applications of the principles of this invention and many other embodiments and modifications may be made without departing from the spirit and scope of the invention as defined in the claims.

What is claimed is:

1. A method of forming a player group relative to a gaming system which includes a plurality of gaming machines comprising the steps of:
receiving input from a first player, said input comprising an identification of at least one second player;
forming a gaming group of said first and at least one second player;
associating a jackpot with said group;
tracking wager-based game play by said first and at least one second player at one or more of said gaming machines of said gaming system;
determining if a player of said group has achieved a jackpot winning criteria; and
if so, awarding at least a portion of said jackpot to said one or more players of said group.

2. A method in accordance with claim 1, further comprising:
transmitting a group invitation to said at least one second player; and
adding said at least one second player to said group if said group invitation is accepted.

3. A method in accordance with claim 1, wherein said identification of at least one second player comprises a name associated with said at least one second player.

4. A method in accordance with claim 1, further comprising providing a map of said plurality of gaming machines, said map including an identifier for each active player associated with said plurality of gaming machines, wherein said identification of at least one second player comprises a selection of said identifier on said map.

5. A method in accordance with claim 1, wherein said jackpot is a progressive jackpot.

6. A method in accordance with claim 1, wherein awarding at least a portion of said jackpot comprises awarding a substantially equal portion of said jackpot to said one or more players of said group.

7. A method of forming a player group relative to a gaming system which includes at least two gaming machines comprising the steps of:
receiving input from a first player of a first gaming machine, said input comprising an identification of at least one selected second gaming machine;
forming a gaming group of said first and said at least one second gaming machine;
associating a jackpot with said group;
tracking wager-based game play at said gaming machines of said group;
determining if a jackpot winning criteria has been met at one of said gaming machines of said group; and
if so, awarding at least a portion of said jackpot at one or more of said gaming machines of said group.

8. A method in accordance with claim 7, wherein tracking wager-based game play comprises tracking wager-based game play using a player tracking system.

9. A method in accordance with claim 7, further comprising providing a map of said at least two gaming machines.

10. A method in accordance with claim 9, wherein said identification of at least one selected gaming machine is based on a location of said at least one selected gaming machine on said map.

11. A method in accordance with claim 7, wherein awarding at least a portion of said jackpot comprises awarding a substantially equal portion of said jackpot to each of said gaming machines in said group.

12. A gaming system that includes at least two gaming machines, said gaming system configured to:
receive input from a first player of a first gaming machine, said input comprising an identification of at least one selected second gaming machine;
form a gaming group of said first and said at least one second gaming machine;
associate a jackpot with said group;
track wager-based game play at said gaming machines of said group;
determine if a jackpot winning criteria has been met at one of said gaming machines of said group; and
if so, award at least a portion of said jackpot at one or more of said gaming machines of said group.

13. A gaming system in accordance with claim 12, wherein said wager-based game play comprises game play of a plurality of games, at least two of said plurality of games being different.

14. A gaming system in accordance with claim 12, wherein said at least one second gaming machine comprises a mobile device.

15. A gaming system in accordance with claim 12, wherein said first gaming machine is located at a first location and said at least one second gaming machine is located at a second location that is remote from said first location.

16. A gaming system in accordance with claim 12, further comprising a player tracking system configured to track wager-based game play at said gaming machines of said group.
